(19) United States
(12) Patent Application Publication
(10) Pub. No.: US 2018/0284829 A1
(43) Pub. Date: Oct. 4, 2018

(54) VOLTAGE REGULATORS WITH IMPROVED POWER SUPPLY REJECTION USING NEGATIVE IMPEDANCE

(71) Applicant: Vidatronic, Inc., College Station, TX (US)

(72) Inventors: Faisal Abdellatif Elseddeek HUSSIEN, Cairo (EG); Sameh Assem Ibrahim, Cairo (EG); Mohamed Mostafa Saber ABOUDINA, Giza (EG); Michael Arn NIX, Austin, TX (US); Moises Emanuel ROBINSON, College Station, TX (US)

(73) Assignee: Vidatronic, Inc., College Station, TX (US)

(21) Appl. No.: 15/477,586

(22) Filed: Apr. 3, 2017

(51) Int. Cl. G05F 1/63; G05F 1/70; G05F 3/06; H02J 3/18; H02P 9/30; H02M 3/337

(52) U.S. Cl. CPC G05F 1/63; G05F 1/70; H02M 3/3376; H02J 3/18; H02P 9/30; G05F 3/06

(57) ABSTRACT

An adaptive negative impedance system for improving power supply rejection (PSR) of a voltage regulator (VR) includes a variable negative impedance circuit with a control input; and a signal adjustment block (SAB), wherein a negative impedance value of the variable negative impedance circuit is dependent on a voltage regulator output current, and wherein the variable negative impedance circuit is a variable negative capacitance circuit and/or a variable negative resistance circuit, and the negative impedance value is a negative capacitance value and/or a negative resistance value.

### FIELD OF INVENTION

This invention relates to a voltage regulator, particularly to improvement of power supply rejection of a voltage regulator.

### BACKGROUND

A voltage regulator is one of the main building blocks in all analog, digital, and Radio Frequency (RF) applications. It is used to generate constant, clean, and accurate supply voltages necessary to power up different blocks. It is also used to provide isolation between different blocks sharing the same supply. This supply isolation (together with other substrate isolation techniques) guarantees proper operation for low-noise blocks in noisy or switching environments.

Voltage regulators can be categorized into linear voltage regulator (e.g., Low Drop-Out (LDO) regulators) and switching voltage regulator (e.g., switching capacitor regulators, and DC-DC switching converters). Further categorization exists for DC-DC switching converters. Step-down DC-DC voltage regulators (Buck converters) generate an output voltage lower than its input voltage. On the other hand, step-up DC-DC voltage regulators (Boost converters) generate an output voltage higher than its input voltage. Other types can have both operations, such as Buck-Boost and Ćuk converter. Throughout this disclosure, the terms “voltage regulator,” “voltage converter,” “regulator,” and “converter” may be used interchangeably depending on the context. Furthermore, the terms “LDO linear voltage regulator” and “LDO” may be used interchangeably depending on the context.

Input-Output isolation for a voltage regulator is defined in terms of power supply rejection (PSR). PSR of a regulator is inversely proportional to the signal power at a certain frequency that appears at the regulator output for a given unit signal power at the same frequency present at the regulator input (supply). The higher the PSR value, the more isolation the regulator can provide.

$$PSR = \frac{1}{Pout ( f ) / Pin ( f )} \qquad ( 1 )$$

Because power supply rejection (PSR) is one of the critical specifications for a voltage regulator, understanding the sources of PSR degradation and improving it plays a critical role in research and industry. Poor PSR performance can drastically affect a building block's performance for any application causing cross talk and signal interference between blocks. PSR improvement techniques have been introduced in the literature to overcome first order degradation effects. These first order effects appear in the error amplifier DC gain and bandwidth. In addition, the regulator output pole plays an important role in PSR.

FIG. 1. Shows a typical PSR curve for a linear voltage regulator (100). The PSR DC value (101) is determined by the loop gain of the LDO (an error amplifier gain in addition to the output stage gain and a feedback factor). The PSR exhibits a first zero, Z1, (102) at a frequency equal to the error amplifier output pole. This zero starts degrading the PSR until it reaches its first pole at P1 (103), which equals the unity gain frequency of the LDO loop. Another pole, P2, (104) appears at a frequency corresponding to the pole frequency at the LDO output. Finally, a zero, Z2, (105) appears at a frequency corresponding to the output capacitor and equivalent series resistance (ESR). If the Output capacitor ESR is negligible, Z2 is pushed to much higher frequencies and can be ignored.

To improve the PSR performance, the curve shown in FIG. 1 has to have lower values across the frequency band of interest. Several techniques have been introduced to achieve this goal. (a) A high DC gain of the LDO loop shifts the overall PSR curve lower by the gain improvement in dB. Although this solution has a good impact on accuracy, it directly affects the loop stability for a constant pole-zero structure. (b) Another approach is to increase the error amplifier bandwidth to push Z1 (102) to higher frequencies, thus reducing the PSR peaking (for a fixed unity gain frequency (UGF) and output pole). This approach results in higher power consumption. (c) Reducing the unity gain frequency (UGF) pushes P1 to lower frequencies and thus reduces the PSR peaking at the expense of the LDO transient performance and speed. (d) finally, having a large output capacitor can reduce the value of P2 reducing the PSR peaking as well. However, this final solution has a direct impact on cost and chip/board area. These tradeoffs make it challenging to improve the PSR performance while maintaining a superior LDO performance with low power consumption and low cost.

These tradeoffs have been resolved using different analog design techniques, such as multipath or feed-forward implementation to compensate for supply leakage path to the output (Mohamed El-Nozahi et al., “High PSR low drop-out regulator with feed-forward ripple cancellation technique,” Solid-State Circuits, IEEE Journal of 45, no. 3 (2010): pp. 565-577; and Ahmed Amer et al., “Low Drop Out Voltage Regulator,” U.S. Patent Application Publication No. 2012/0212199 A1) and notch filter techniques to reject specific frequency components. Another technique (Seong Jin Yun et al., “Capless LDO Regulator Achieving −76 dB PSR and 96.3 fs FOM,” IEEE Transactions on Circuits and Systems II: Express Briefs, Year: 2016, DOI: 10.1109/TCSII.2016.2628965) is to use a fixed negative capacitor to cancel the effect of gate-to-ground capacitance of a PMOS power transistor as shown in FIG. 2.

While the prior art approaches are effective in achieving PSR improvements, there is still a need for better approaches to further PSR improvements.

### SUMMARY

Embodiments of the invention relate to improved PSR performance of voltage regulators by addressing secondary effects that may degrade PSR performance. These second order effects may be caused by variations in the output impedance (resistance and/or capacitance) of a main pass transistor and its variations with respect to the output load currents. Embodiments of the invention relate to systems and methods for PSR improvement by tackling second order effects, such as parasitic gate-to-drain capacitance (including C_{gd}), parasitic gate-to-source capacitance (including C_{gs}), parasitic drain-to-source capacitance, and output resistance (rds) of the pass transistor. These systems or methods are based on implementation of “negative impedance,” i.e., an equivalent negative capacitance and/or resistance, into a voltage regulator.

As used herein, the term “negative impedance” includes an equivalent negative capacitance and/or an equivalent negative resistance. In accordance with some embodiments of the invention, an equivalent negative capacitance circuit is used to address the secondary effects. In accordance with some embodiments of the invention, an equivalent negative resistance circuit is used to address the secondary effects. Furthermore, in accordance with some embodiments of the invention, both an equivalent negative capacitance circuit and an equivalent negative resistance circuit are used to address the secondary effects.

In accordance with embodiments of the invention, a first method relies on adding an equivalent negative capacitance connected across the C_{gd} of the pass transistor to reduce its degradation to the regulator PSR.

In accordance with embodiments of the invention, a second method is to add an equivalent negative resistance across the output resistance (rds) of the pass transistor to maximize its overall value and a negative capacitance across the output capacitance (C_{ds}) to minimize its overall value and thus reduce their effect on PSR performance. The output capacitance is the overall parasitic capacitance between the drain and the source of the pass transistor. This includes Cdb if the source of the pass transistor is connected to its bulk.

In accordance with some embodiments of the invention, a combination of these two methods may be used to improve the PSR performance, by using an equivalent negative capacitance and an equivalent negative resistance.

One aspect of the invention relates to systems for improving power supply rejection (PSR) of a voltage regulator (VR). A system in accordance with one embodiment of the invention includes a variable negative impedance circuit with a control input; and a signal adjustment block (SAB), wherein a negative impedance value of the variable negative impedance circuit is dependent on a voltage regulator output current, and wherein the variable negative impedance circuit is a variable negative capacitance circuit and/or a variable negative resistance circuit, and the negative impedance value is a negative capacitance value and/or a negative resistance value.

In accordance with the above embodiments, the voltage regulator may comprise a pass transistor of a type selected from the group consisting of N-type metal-oxide-semiconductor (NMOS), P-type metal-oxide-semiconductor (PMOS), N-type field-effect transistor (NFET), P-type field-effect transistor (PFET), N-type fin field-effect transistor (NFIN), and P-type fin field-effect transistor (PFIN).

In accordance with some embodiments of the invention, the variable negative impedance circuit is the variable negative capacitance circuit, and the negative impedance value is the negative capacitance value. The variable negative capacitance circuit has a first terminal connected to a drain of the pass transistor and a second terminal connected to one selected from the group consisting of a gate and a source of the pass transistor. The control input of the variable negative capacitance circuit is connected to an output of the SAB, and an input of the SAB is connected to a gate of the pass transistor or any other internal node that carries the information of the regulator output current.

In accordance with some embodiments of the invention, the adaptive negative impedance circuit is the variable negative resistance circuit and the negative impedance value is the negative resistance value. The variable negative resistance circuit has a first terminal connected to a drain of the pass transistor and a second terminal connected to a source of the pass transistor. The control input of the variable negative resistance circuit is connected to an output of the SAB, and an input of the SAB is connected to a gate of the pass transistor or any other internal node that carries the information of the regulator output current.

In accordance with some embodiments of the invention, the adaptive negative impedance circuit comprises the variable negative capacitance circuit and the variable negative resistance circuit, and the negative impedance value comprises the negative capacitance value and the variable negative resistance value. The variable negative resistance circuit has a first terminal connected to an output of an error amplifier and a second terminal connected to an input supply. The control input of the variable negative resistance circuit is connected to the output of the SAB, and the input of the SAB is connected to the gate of the pass transistor or any other internal node that carries the information of the regulator output current.

One aspect of the invention relates to C-NegC systems for adding a negative capacitance across a capacitor of interest without changing an overall capacitance at a signal node. A C-NegC system in accordance with one embodiment of the invention comprises: a variable negative capacitance circuit; and a positive capacitance element, wherein the negative capacitance circuit is connected between the signal node and a first supply rail, and wherein the positive capacitance element is connected between the signal node and a second supply rail. The negative capacitance circuit has an equivalent negative capacitance equals in magnitude to a capacitance of the positive capacitance element.

One aspect of the invention relates to R-NegR system for adding a negative resistance across a resistor of interest without changing an overall resistance at a signal node, comprises: a variable negative resistance circuit; and a positive resistance element, wherein the negative resistance circuit connected between the signal node and a first supply rail, and wherein the positive resistance element connected between the signal node and a second supply rail. The negative resistance circuit has an equivalent negative resistance equals in magnitude to a resistance of the positive resistance element.

Other aspects of the invention will be apparent from the following detailed description and the appended claims.

### BRIEF DESCRIPTION OF DRAWINGS

The appended drawings are used to illustrate several embodiments of the invention and are not to be considered limiting of its scope, for the invention may admit to other equally effective embodiments.

FIG. 1 shows a typical PSR behavior for a linear voltage regulator (LDO).

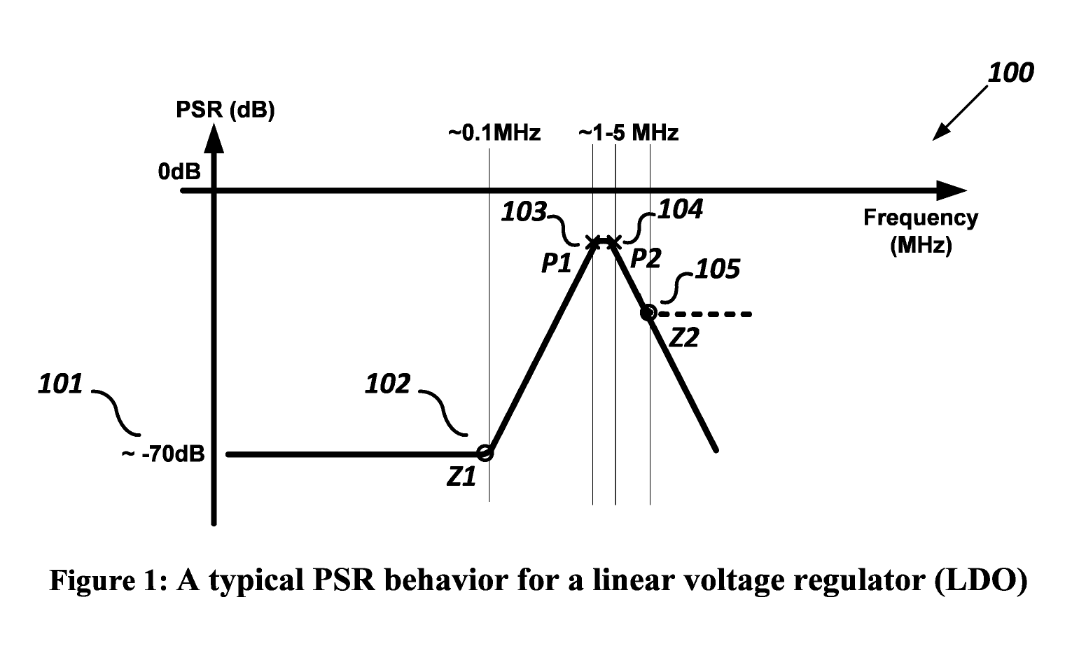

FIG. 2 shows a prior art method using a fixed negative capacitor to cancel the gate-to-ground capacitor of the PMOS power device.

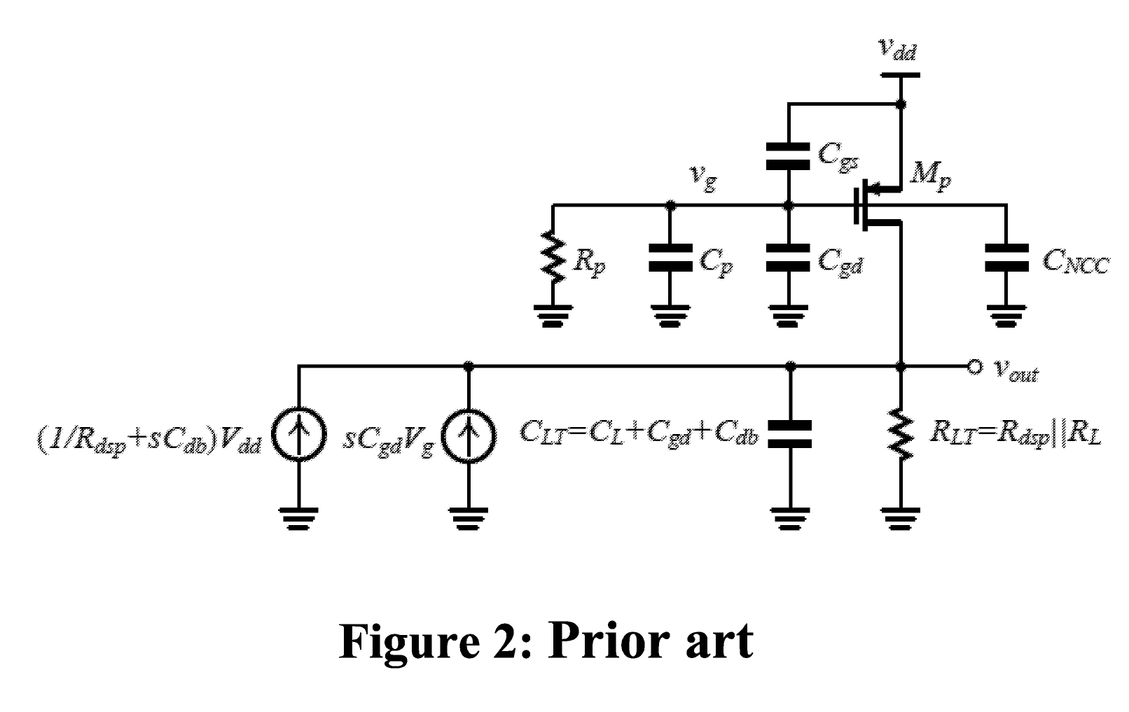

FIG. 3 shows a typical NMOS pass transistor LDO with parasitic capacitances.

FIG. 4 shows a modified NMOS pass transistor LDO with a buffer stage inserted between its error amplifier and its pass transistor.

FIG. 5 shows, in accordance with one embodiment of the invention, a modified LDO with negative equivalent capacitor attached to C_{gd} and the corresponding simulation results for an LDO test example.

FIG. 6 shows simulation results for an LDO test example according to one embodiment of the invention after adding negative resistance across rds.

FIG. 7 shows a modified LDO with negative equivalent capacitor attached to output capacitance (C_{ds}) in accordance with one embodiment of the invention.

FIG. 8 shows a modified LDO with negative equivalent resistance attached to error amplifier output resistance in accordance with one embodiment of the invention.

FIG. 9 shows the C-negC and R-negR implementation to maintain the regulator loop dynamics while improving PSR in accordance with embodiments of the invention.

FIG. 10 shows Floating negative capacitance implementation and proper connection to an NMOS pass transistor LDO in accordance with embodiments of the invention.

FIG. 11 shows a grounded negative capacitance implementation and proper connection to an NMOS pass transistor LDO in accordance with embodiments of the invention.

FIG. 12 shows a floating negative impedance implementation in accordance with embodiments of the invention.

### DETAILED DESCRIPTION

Embodiments of the present invention are illustrated in the above-identified drawings and the following description. In the drawings and the description, like or identical reference numerals are used to identify common or similar elements. The drawings are not necessarily to scales and certain features may be shown exaggerated in scale or in schematic in the interest of clarity and conciseness.

Embodiments of the invention relate to inventive methods for improving PSR performance of voltage regulators; these methods add negative impedance (i.e., negative capacitance and/or negative resistance) to the voltage regulators. The negative impedance, which may be negative capacitance, negative resistance, or a combination of the two, may be implemented with a circuit that produce an equivalent negative capacitance and/or an equivalent resistance.

In accordance with embodiments of the invention, a negative capacitance circuit and/or a negative resistance circuit may be implemented on a microchip, such as a semiconductor integrated circuit. In accordance with some embodiments of the invention, the negative capacitance and/or negative resistance circuits may be implemented in a voltage regulator. For example, the negative capacitance and negative resistance circuits may be implemented in an LDO linear voltage regulator. Those skilled in the art, with the benefit of this disclosure will appreciate that the negative capacitance and/or negative resistance circuits may also be used in other types of voltage references circuits.

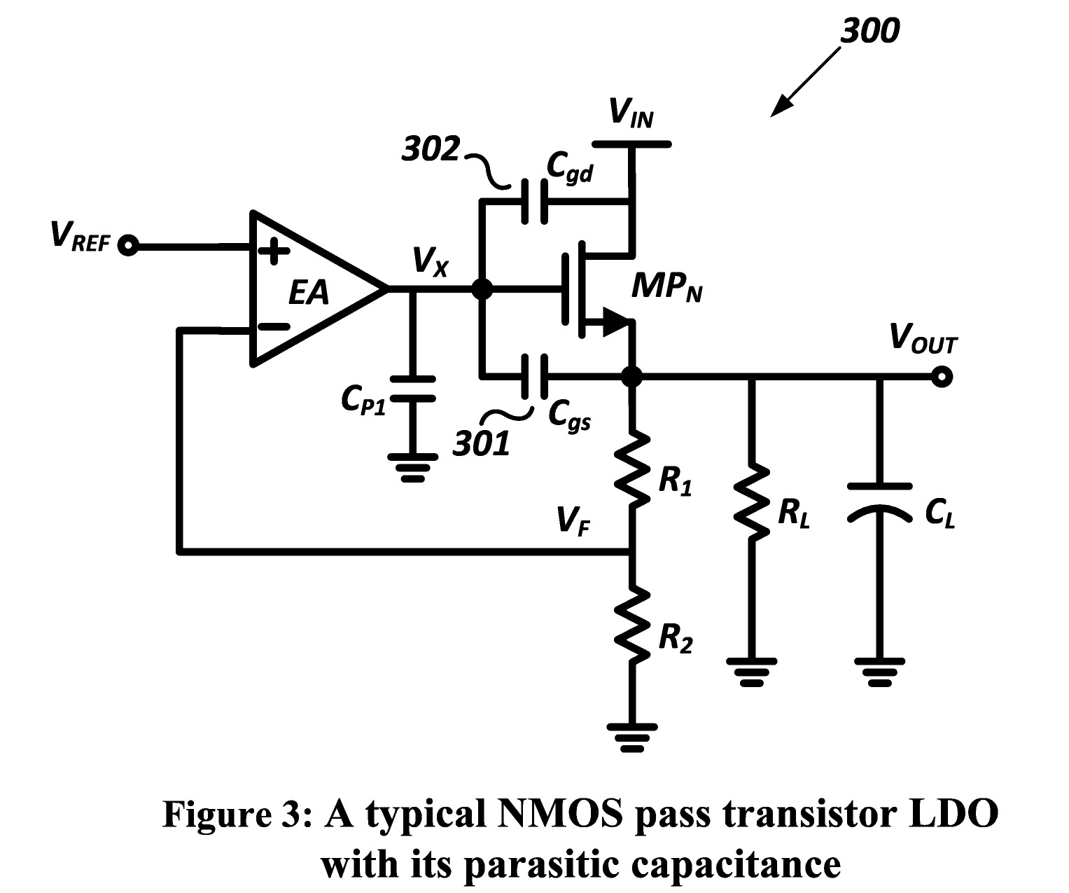

FIG. 3 shows a typical NMOS pass transistor LDO (300) with the NMOS parasitic capacitors drawn, C_{gs} (301) and C_{gd} (302). It can be proven that the PSR is given by eq. (2):

$$PSR = \frac{{V}_{o} ( s )}{{V}_{in} ( s )} = \frac{1}{β \cdot {A}_{EA} \cdot {A}_{PT} + \frac{{r}_{ds} {C}_{gs}}{{A}_{PT}} S} = \frac{1}{β \cdot {A}_{EA} \cdot {A}_{PT} ( 1 + \frac{{r}_{ds} {C}_{gs}}{β \cdot {A}_{EA} \cdot {A}_{PT}^{2}} S )} \qquad ( 2 )$$

Where A_{EA} is the error amplifier DC gain, A_{PT} is the NMOS pass transistor intrinsic gain (gₘ·r_{ds}), and β is the feedback factor

$$( \frac{{R}_{2}}{{R}_{1} + {R}_{2}} ) .$$

Equation (2) indicates that the approximated pole of the PSR performance curve is located at

$$( {w}_{p} = \frac{β \cdot {A}_{EA} \cdot {A}_{PT}^{2}}{{r}_{ds} {C}_{gs}} ) .$$

Based on this analytical study, one can identify three main second order effects that can degrade PSR performance: (1) R_{OE} (error amplifier output impedance), the lower the better for bandwidth extension; (2) C_{gd} (and C_{gs}) (MP parasitic capacitance), the lower the better; and (3) Rds (MP output resistance), the higher the better. Moreover, the output capacitance (C_{ds}, that includes routing parasitic capacitance and C_{db} for source-bulk connection devices) for large power devices build up a capacitor divider with an output capacitance (Cload). This capacitor divider injects supply noises directly into the output node especially for cap-less or low-output-capacitor regulators.

In addition, the value of C_{ds} appears at the gate of the pass transistor amplified by the power transistor gain ((1+A_{PT})*Cds). Thus, (C_{ds}) is one of the key parasitic capacitances that need to be reduced for high PSR performance.

Embodiments of the invention aim to address these secondary effects of unwanted capacitance and/or resistance. In accordance with embodiments of the invention, these undesired secondary effects may be eliminated or minimized by implementing a proper “negative impedance” in a voltage regulator. The “negative impedance” may be negative capacitance, negative resistance, or a combination of both the negative capacitance and the negative resistance. The negative capacitance and/or negative resistance may be achieved using circuits that generate an equivalent negative value in capacitance and/or resistance. One skilled in the art would appreciate that various implementations of such circuits are possible. The following will describe some examples that may be used with embodiments of the invention. One skilled in the art would appreciate that these examples are for illustration only and other variations and modifications are possible without departing from the scope of the invention.

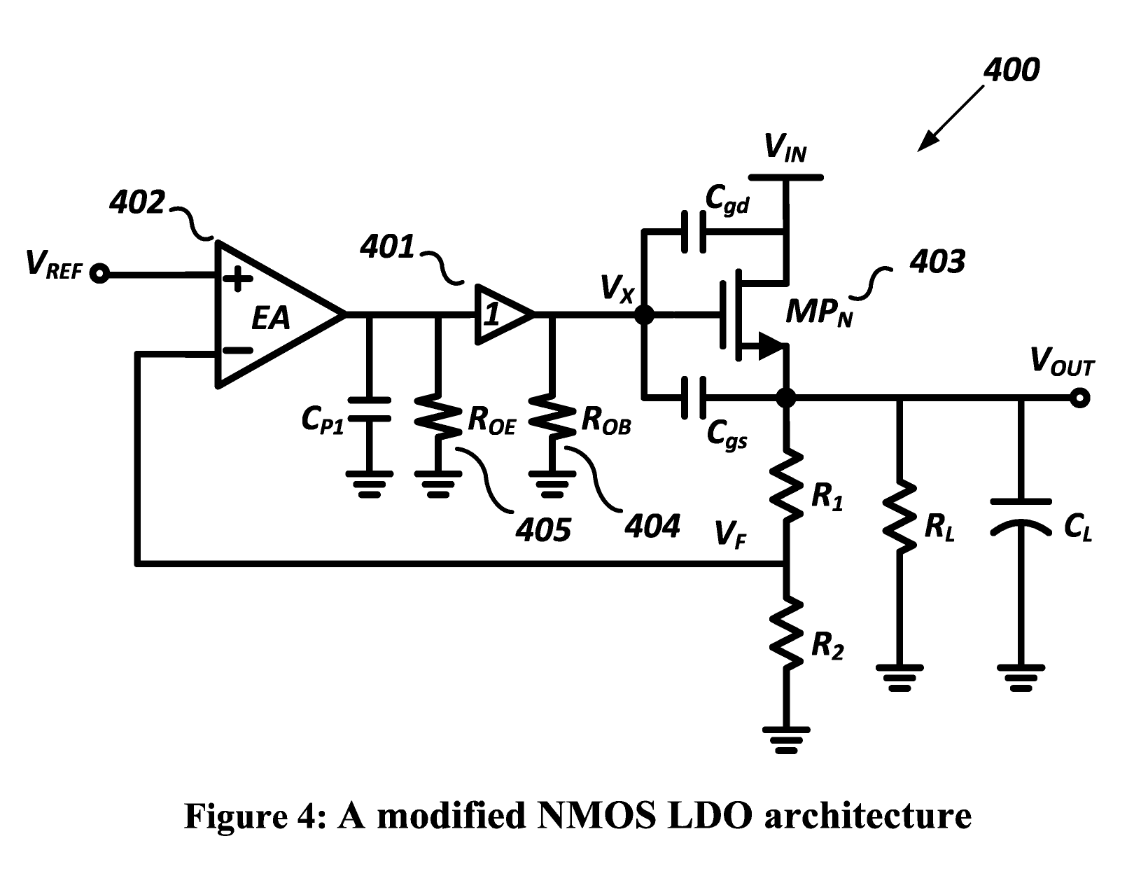

FIG. 4 shows an example of a modified LDO architecture (400), wherein an intermediate stage (401) is inserted between an error amplifier output (402) and the pass transistor (403) gate. This intermediate stage can be a single stage source follower or a negative feedback buffer. Thus, the effective output impedance R_{OB} (404) seen by the pass transistor is lower than R_{OE} (405) of the error amplifier. In this example, the intermediate stage (401) is equivalent to a negative resistance.

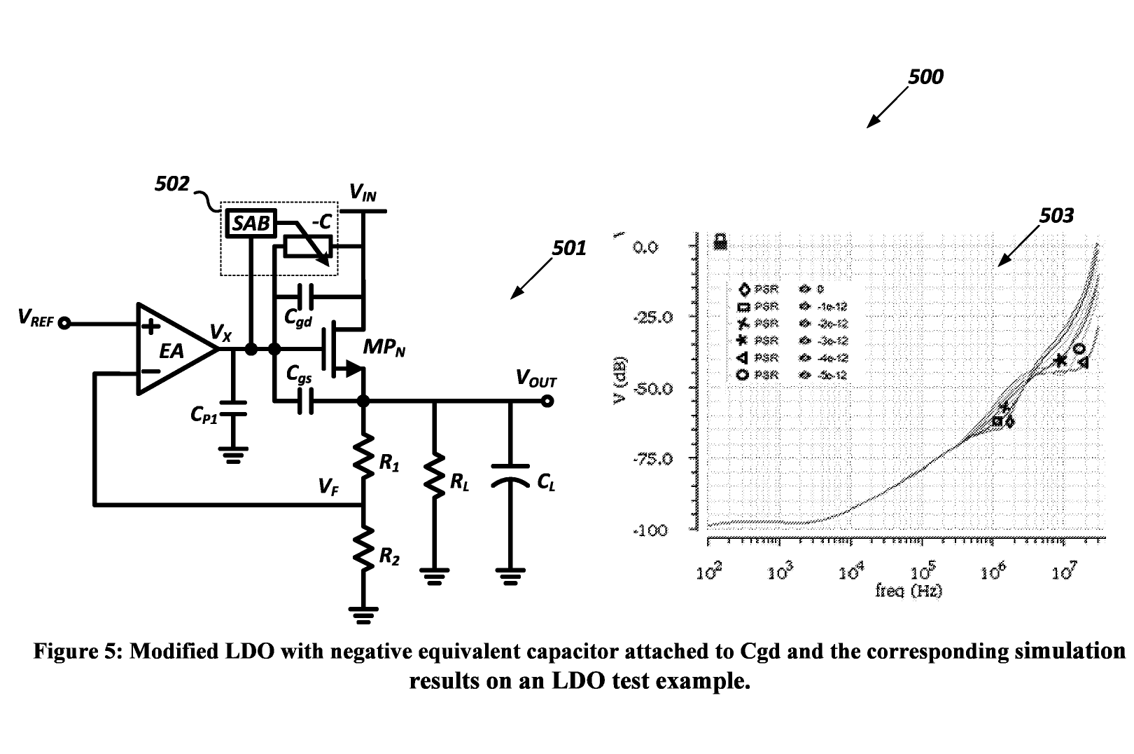

One approach to reducing the value C_{gs} of an NMOS pass transistor without affecting its size, gain, and current capability is to add an equivalent negative capacitance across it. FIG. 5 shows an example of a modified LDO architecture (501) with a negative equivalent capacitor (502). FIG. 5 also shows the PSR simulation results for an LDO test example (503) after adding various values of negative capacitance to C_{gd} to reduce its value. The simulation results for this example show that all improvements are achieved at high frequencies (above 500 KHz). For example, an improvement of 15 dB is achieved at 10 MHz by adding −4 pF. This case also maintains 30 dB of PSR up to 28 MHz.

Because C_{gd} value is a function of the load currents, different load current values would correspond to different optimum negative capacitances for PSR improvement. Thus, PSR improvement can be achieved through an adaptive implementation of a negative capacitance based on the load current levels.

An exemplary adaptive implementation is to extract the load current information from the gate of the pass transistor, pass it through a signal adjustment block (SAB), and inject it into the negative capacitance circuit implementation as shown in (502). The signal adjustment block (SAB) is used to level-shift, apply a non-zero gain, convert the signal nature (e.g., voltage to current), or any combination of the these functions.

In accordance with embodiments of the invention, one or more of the modules and elements shown in the example of FIG. 5 may be omitted, repeated, and/or substituted. Accordingly, embodiments of the invention should not be considered limited to the specific arrangements of modules shown in the example of FIG. 5.

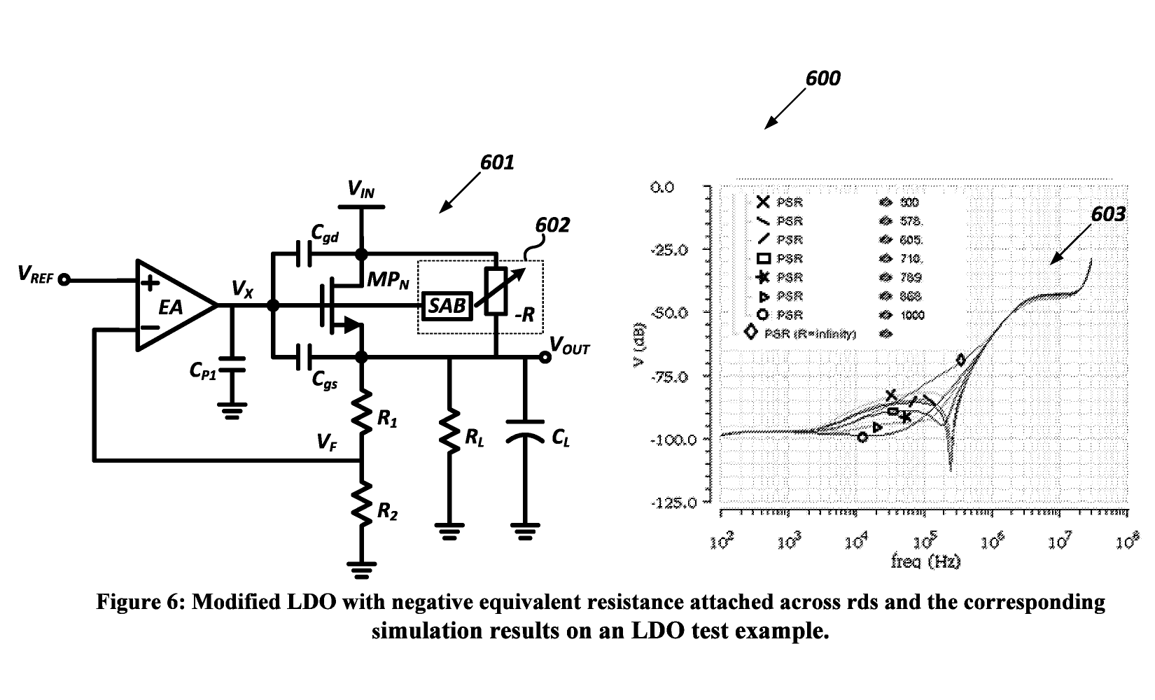

The example shown in FIG. 5 uses negative capacitance. Some embodiments of the invention use negative resistance. FIG. 6 shows an example of a modified LDO architecture with a negative equivalent resistor (602) connected across the output resistance of the pass transistor (Rds). FIG. 6 also shows the PSR simulation results on an LDO test example (603) after adding various values of negative impedance to rds to increase its value. It is clear from the simulation results that improvements can be achieved at mid frequencies (1 KHz to 500 KHz). In addition, a notch can be formed at an arbitrary frequency to eliminate a known source of noise injected to the LDO supply. A relative improvement of 13 dB is achieved at 100 KHz by adding −800Ω resistive impedance in this example.

Because Rds value is a function of the load currents, different load current values would correspond to different optimum negative resistances for PSR improvement. This can be achieved through an adaptive implementation of the negative resistance based on the load current levels.

An exemplary adaptive implementation is to extract the load current information from the gate of the pass transistor, pass it through a signal adjustment block (SAB), and inject it into the negative resistance circuit implementation as shown in (601). The signal adjustment block (SAB) is used to level-shift, apply an non-zero gain, convert the signal nature (e.g., voltage to current), or any combination of the these functions.

In accordance with embodiments of the invention, one or more of the modules and elements shown in the example of FIG. 6 may be omitted, repeated, and/or substituted. Accordingly, embodiments of the invention should not be considered limited to the specific arrangements of modules shown in the example of FIG. 6.

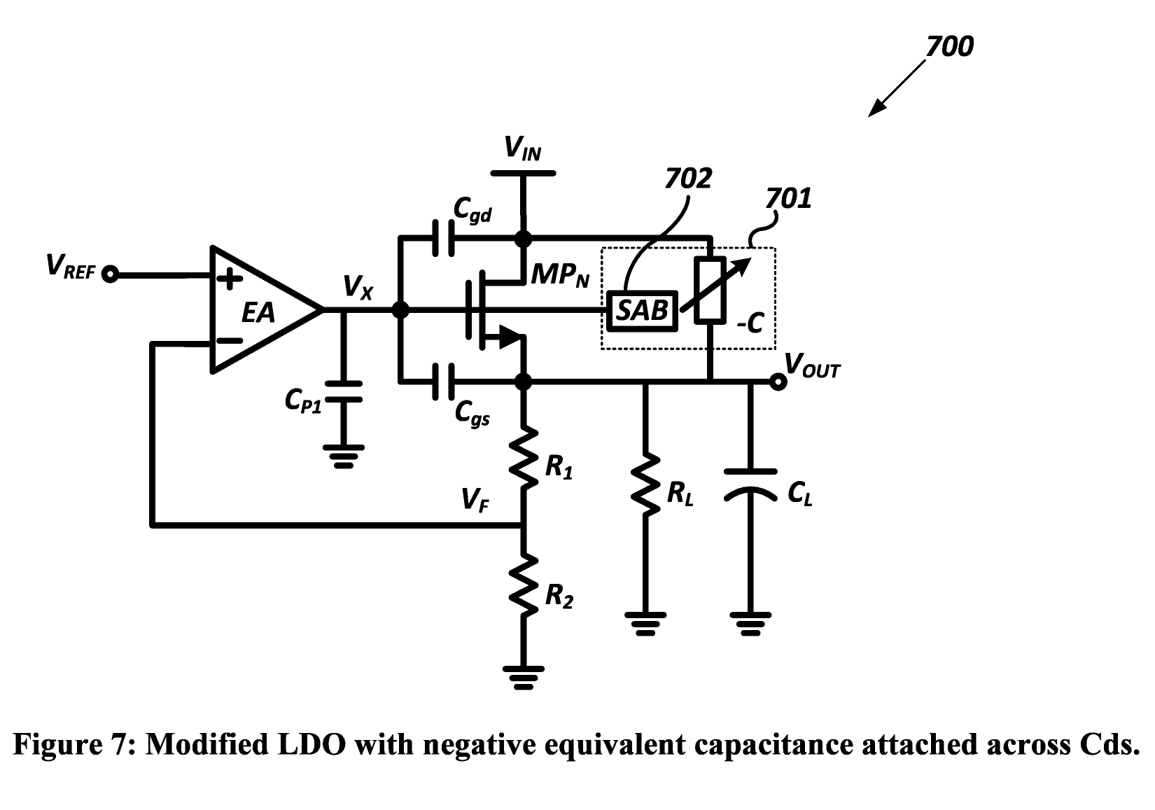

Moreover, FIG. 7 shows a modified LDO architecture with a negative equivalent capacitance (701) connected across the output capacitance of the pass transistor (C_{ds}, that includes routing parasitic capacitance and Cdb for source-bulk connection devices) to reduce its value. Because C_{ds} value is a function of the power device operating point (which is a function of the load currents), different load current values would correspond to different optimum negative capacitances for PSR improvement. This can be achieved through an adaptive implementation of the negative capacitance based on the load current levels.

An exemplary adaptive implementation is to extract the load current information from the gate of the pass transistor, pass it through a signal adjustment block (SAB), and inject it into the negative capacitance circuit implementation as shown in (702). The signal adjustment block (SAB) is used to either level-shift, apply an non-zero gain, convert the signal nature (e.g., voltage to current), or any combination of the these functions.

In accordance with embodiments of the invention, one or more of the modules and elements shown in the example of FIG. 7 may be omitted, repeated, and/or substituted. Accordingly, embodiments of the invention should not be considered limited to the specific arrangements of modules shown in the example of FIG. 7.

As noted in PSR analysis, the output resistance of an error amplifier can affect PSR performance. In addition, as a high impedance node, this output resistance directly affects the regulator loop dynamics. Given that this resistance is a parallel combination of P-side resistance (R_{P}) and N-side resistance (R_{N}), one can conclude that: (1) R_{P} affects the PSR performance; and (2) R_{P}/R_{N} contributes to the loop dynamics. Thus, reducing Rₚ, while maintaining the parallel combination at its desired value, is the goal for a robust design.

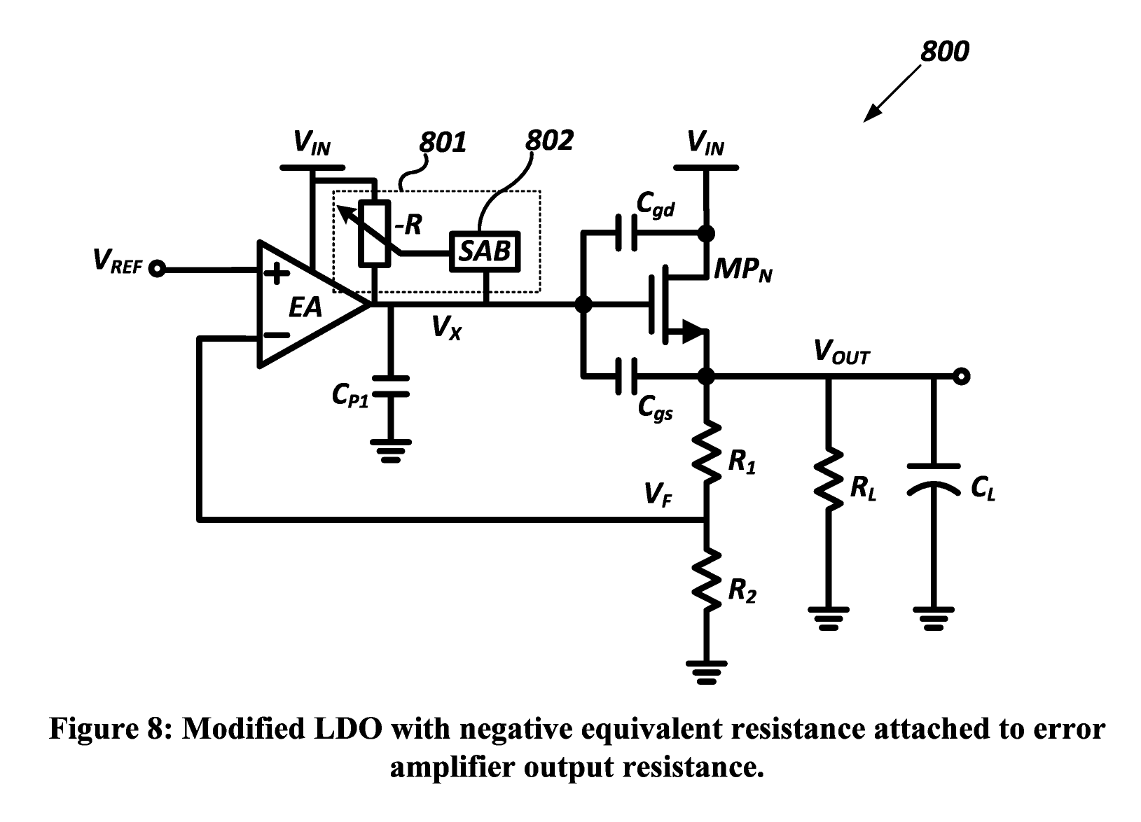

FIG. 8 shows a modified LDO architecture with a negative equivalent resistance (801) connected across the output resistance (R_{P}) of the error amplifier. Because R_{P} value is a function of the regulator operating point (which is function of the load currents), different load current values would correspond to different optimum negative resistances for PSR improvement. This can be achieved through an adaptive implementation of the negative resistance based on the load current levels.

Similarly, an exemplary adaptive implementation is to extract the load current information from the gate of the pass transistor, pass it through a signal adjustment block (SAB), and inject it into the negative resistance circuit implementation as shown in (802). The signal adjustment block (SAB) is used to level-shift, apply an non-zero gain, convert the signal nature (e.g., voltage to current), or any combination of the these functions.

In accordance with embodiments of the invention, one or more of the modules and elements shown in the example of FIG. 8 may be omitted, repeated, and/or substituted. Accordingly, embodiments of the invention should not be considered limited to the specific arrangements of modules shown in the example of FIG. 8.

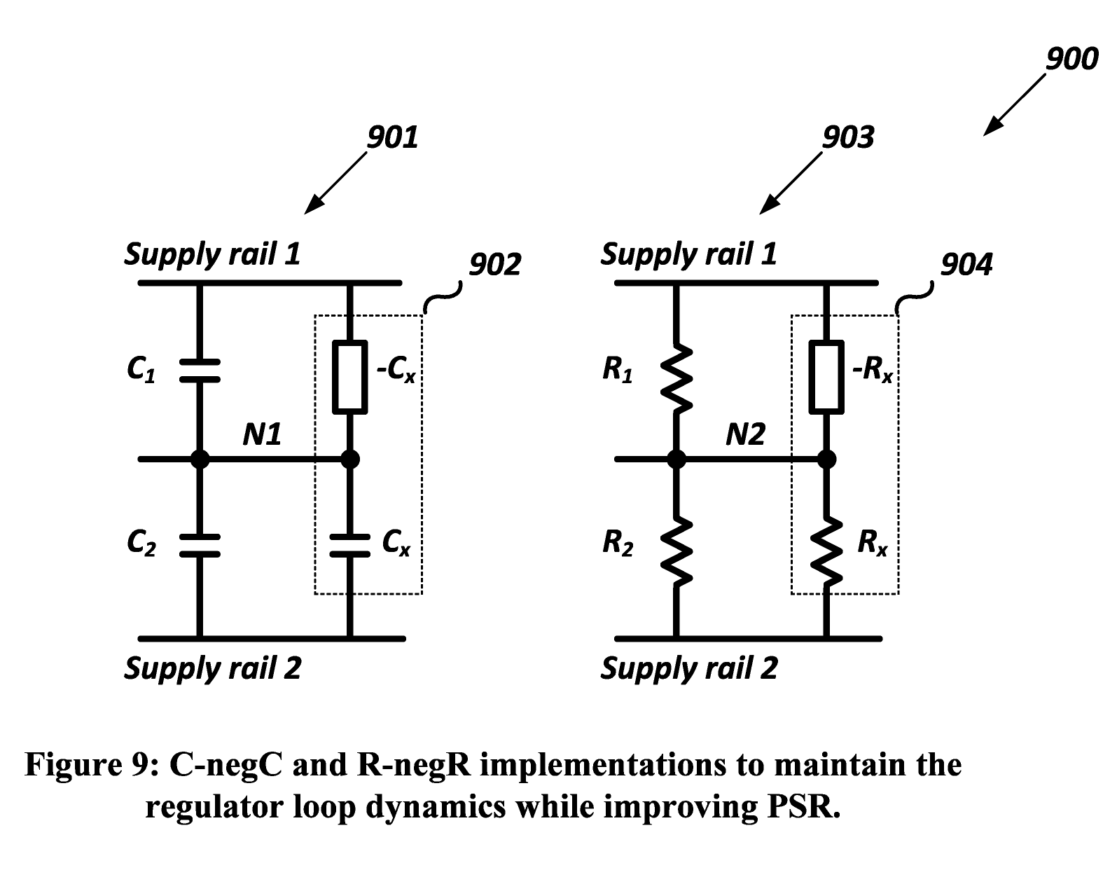

Generally, adding a negative resistance and/or capacitance to a specific node will alter its loop dynamics. This can be designed properly to make good use of this additional feature. In some cases, a trade-off appears that may require performance compromise in either PSR or loop dynamics. FIG. 9 shows a C-negC method/system and an R-negR method/system that can be implemented at a node of interest. These methods/systems may help to preserve the overall capacitance/resistance at the same node while affecting only the PSR degradation element. Thus, these may achieve the improvement in PSR performance without impacting the loop (or node) dynamics.

As used herein, the term “C-negC” system refers to a system having a positive capacitor element and a variable negative capacitance circuit, wherein the negative capacitance circuit has an equivalent negative capacitance equals in magnitude to a capacitance of the positive capacitance element. As used herein, the term “R-negR” system refers to a system having a positive resistor element and a variable negative resistor circuit, wherein the negative resistor circuit has an equivalent negative resistance equals in magnitude to the resistance of the positive resistor element.

As shown in FIG. 9, a C-negC method/system (901) may be implemented by adding an equivalent negative capacitance (−Cx) across a capacitor of interest (C₁) and supply rail 1. At the same time, a similar positive capacitance (C_{X}) is connected at the same node N1 and the other supply rail 2 (902). As a result, the overall capacitance at node N1 remains (C₁+C₂), while C₁ is reduced by a value of (C_{X}).

Similarly, an R-negR method/system (903) may be implemented by adding an equivalent negative resistance (−R_{X}) across the resistor of interest (R₁) and supply rail 1. At the same time, a similar positive resistance (R_{X}) is connected at the same node N2 and the other supply rail 2 (904). As a result, the overall resistance at node N2 remains unchanged (R₁ in parallel with R₂), while R₁ is reduced by a value of (R_{X}).

In accordance with embodiments of the invention, one or more of the modules and elements shown in the example of FIG. 9 may be omitted, repeated, and/or substituted. Accordingly, embodiments of the invention should not be considered limited to the specific arrangements of modules shown in the example of FIG. 9.

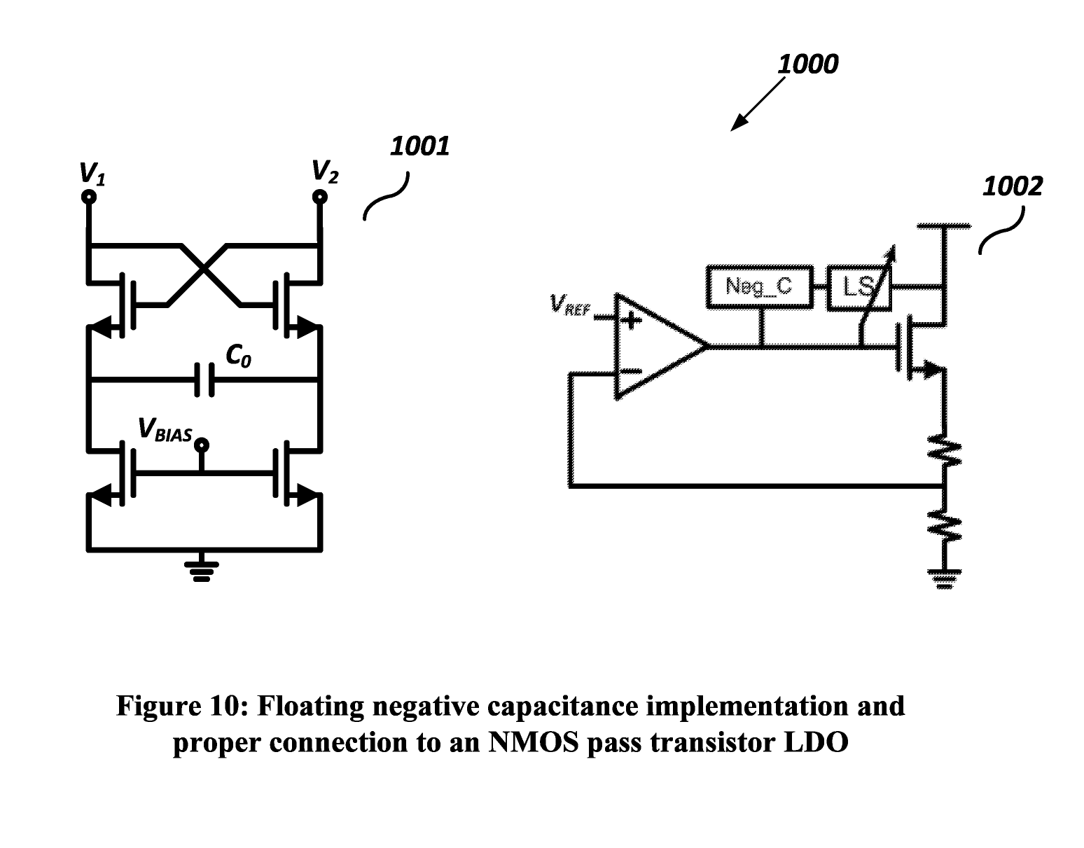

The implementation of a negative capacitance and/or negative resistance can be achieved using controlled and programmable positive feedback circuits. FIG. 10 shows an example of a floating cross coupled implementation of a negative impedance (1001), where its input impedance is given by eq. (3).

$${Z}_{in} = - \frac{2}{{g}_{m}} - \frac{1}{SC} \qquad ( 3 )$$

For proper operations, as a negative capacitor, the two cross coupled terminals (V1 and V2) should be DC balanced. This can be achieved using proper DC coupling through level shifting (1002). Any level shifter implementation that satisfies the input/output voltage dynamic ranges can be used. An example of a typical design implementation is shown in (G. Maderbacher et al., “Fast and robust level shifters in 65 nm CMOS,” Proceedings of the ESSCIRC pp. 195,198, 12-16 Sep. 2011). This Negative impedance implementation can be used to obtain a lossy negative capacitance that reduces the overall efficiency and also requires an additional circuit for proper DC biasing.

The same implementation can be used to obtain a negative resistance (when C˜=0). Where V1 and V2 can be connected to the drain-source nodes of the pass transistor, V_{BIAS} can be used as the adaptive control to track the load current value for optimum operation across the load dynamic range. Similarly, it is required to have a level shifter at one of the terminals to maintain the required DC-balance.

This implementation example is optimized for an NMOS pass transistor. Those skilled in the art, with the benefit of this disclosure, will appreciate that other circuit implementations may also be used without departing from the scope of the invention.

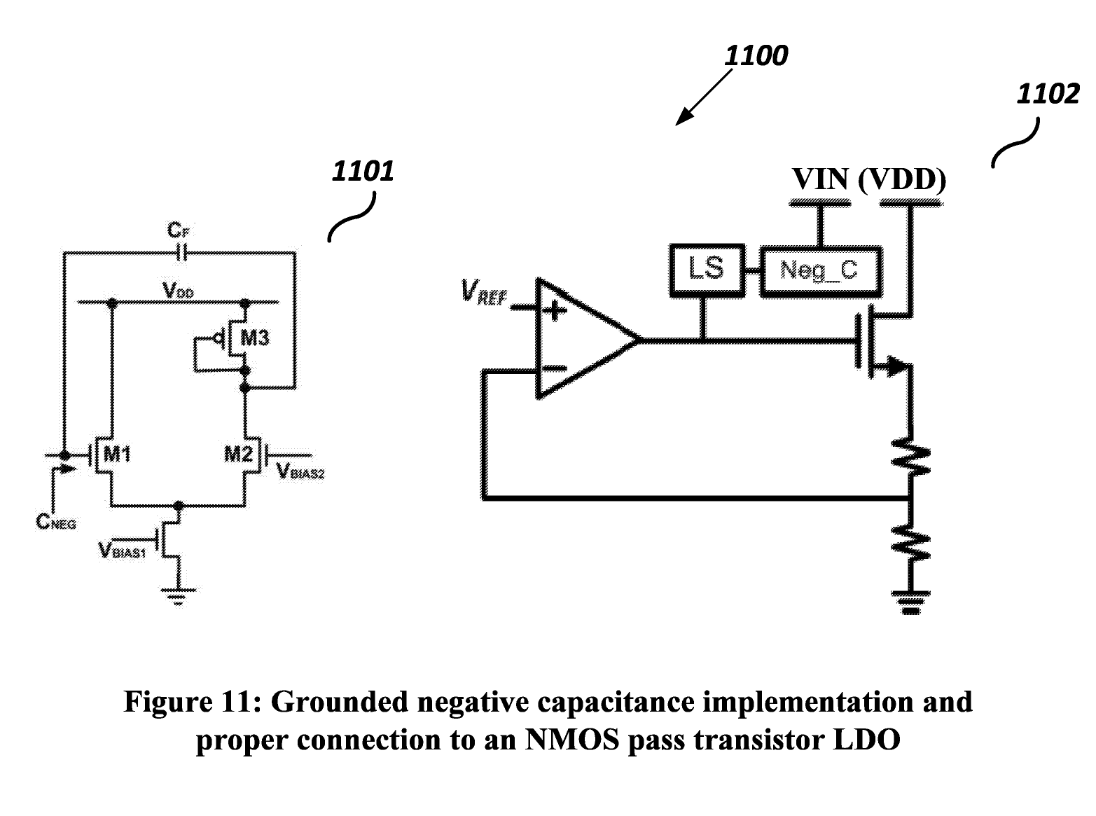

Another example of a negative capacitance implementation is shown in FIG. 11. A grounded implementation can be used (1101) to overcome the inaccuracy resulting in unbalanced DC conditions of the floating structure (1101). The complementary implementation of (1101) can fit in this application as the drain of the NMOS pass transistor is connected to VIN similar to the reference terminal of the complementary version of (1101). In some cases and based on the signal swing at the NMOS gate, a Level shifter can be used, while it may not be needed in other applications.

Similarly, a negative resistance implementation can be achieved using (1101) by replacing (C_{F}) with a resistive component (R_{F}), where the input of the complementary structure is connected to the source of the NMOS transistor.

Same techniques of applying negative capacitance and/or negative resistance to improve PSR can be applied to different transistor types including, but not limited to, N-type metal-oxide-semiconductor (NMOS), P-type metal-oxide-semiconductor (PMOS), N-type field-effect transistor (NFET), P-type field-effect transistor (PFET), N-type fin field-effect transistor (NFIN), and P-type fin field-effect transistor (PFIN). In addition, irrespective of the feedback technique used, the number of outputs, or the number of feedback loops, the same techniques may be applied.

Moreover, adding a circuit emulating a negative resistance across the output impedance of the power (pass) transistor reduces the LDO output impedance and thus changes the pole frequency at the output. This affects the dynamic operation of the LDO and can be optimized to improve its bandwidth and thus transient performance; increasing the loop bandwidth.

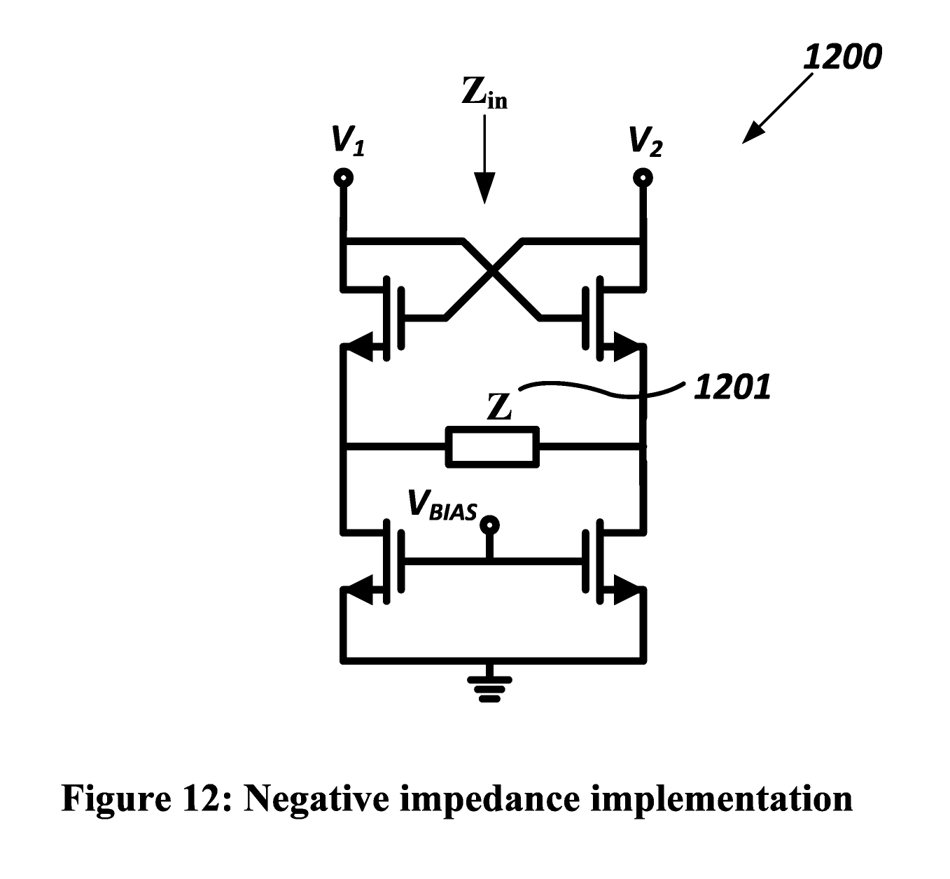

Furthermore, adding a negative impedance (active and reactive parts) leads to a pole/zero combination that can be placed properly to improve the LDO bandwidth and dynamic performance through canceling the equivalent series resistance (ESR) effect of an output capacitor, canceling a non-dominant pole, or adding an in-band zero. As shown in FIG. 12, the equivalent input impedance can be given by (4):

$${Z}_{in} = - \frac{2}{{g}_{m}} - Z \qquad ( 4 )$$

The impedance Z (1201) is a combination of R and C components chosen to improve the dynamic performance of the LDO beside improving the PSR performance.

This implementation example is illustrated for NMOS pass transistor. Those skilled in the art, with the benefit of this disclosure, will appreciate that other circuit implementations may also be used without departing from the scope of the invention.

Advantages of embodiments of the invention may include one or more of the following: Embodiments of the invention, by addressing secondary effects, can improve PSR performance beyond what is achievable in the prior art. Therefore, embodiments of the invention may have better PSR performance improvements. In addition, implementation of equivalent negative capacitance and/or resistance can use simple circuits, rendering it simple and easy to implement even when implemented on the same substrate as the voltage regulators. Moreover, these circuit implementations can add poles/zeros to the overall regulator transfer function. This adds more degrees of freedom for stability and transient performance.

Embodiments of the invention have been illustrated with a limited number of examples. One skilled in the art would appreciate that other variations and modifications are possible without departing from the scope of the invention. Therefore, the scope of protection of this invention should only be limited by the appended claims.

What is claimed is:

1. An adaptive negative impedance system for improving power supply rejection (PSR) of a voltage regulator (VR), comprising:
a variable negative impedance circuit with a control input; and
a signal adjustment block (SAB),
wherein a negative impedance value of the variable negative impedance circuit is dependent on a voltage regulator output current, and
wherein the variable negative impedance circuit is a variable negative capacitance circuit and/or a variable negative resistance circuit, and the negative impedance value is a negative capacitance value and/or a negative resistance value.

2. The adaptive negative impedance system of claim 1, wherein the voltage regulator comprises a pass transistor of a type selected from the group consisting of N-type metal-oxide-semiconductor (NMOS), P-type metal-oxide-semiconductor (PMOS), N-type field-effect transistor (NFET), P-type field-effect transistor (PFET), N-type fin field-effect transistor (NFIN), and P-type fin field-effect transistor (PFIN).

3. The adaptive negative impedance system of claim 2, wherein the variable negative impedance circuit is the variable negative capacitance circuit, and the negative impedance value is the negative capacitance value.

4. The adaptive negative impedance system of claim 3, wherein the variable negative capacitance circuit has a first terminal connected to a drain of the pass transistor and a second terminal connected to one selected from the group consisting of a gate and a source of the pass transistor.

5. The adaptive negative impedance system of claim 3, wherein the control input of the variable negative capacitance circuit is connected to an output of the SAB, and an input of the SAB is connected to a gate of the pass transistor.

6. The adaptive negative impedance system of claim 2, wherein the adaptive negative impedance circuit is the variable negative resistance circuit and the negative impedance value is the negative resistance value.

7. The adaptive negative impedance system of claim 6, wherein the variable negative resistance circuit has a first terminal connected to a drain of the pass transistor and a second terminal connected to a source of the pass transistor.

8. The adaptive negative impedance system of claim 6, wherein the variable negative resistance circuit has a first terminal connected to an output of an error amplifier and a second terminal connected to an input supply.

9. The adaptive negative impedance system of claim 6, wherein the control input of the variable negative resistance circuit is connected to an output of the SAB, and an input of the SAB is connected to a gate of the pass transistor.

10. The adaptive negative impedance system of claim 1, wherein the SAB provides at least one selected from the group consisting of a non-zero gain and a signal transformation.

11. The adaptive negative impedance system of claim 1, wherein a pole and a zero of the adaptive negative impedance system are adjusted to improve a VR dynamic range.

12. The adaptive negative impedance system of claim 1, wherein the adaptive negative impedance circuit comprises the variable negative capacitance circuit and the variable negative resistance circuit, and the negative impedance value comprises the variable negative capacitance value and the variable negative resistance value.

13. The adaptive negative impedance system of claim 12, wherein the variable negative resistance circuit has a first terminal connected to a drain of the pass transistor and a second terminal connected to a source of the pass transistor, and/or wherein the variable negative capacitance circuit has a first terminal connected to a drain of the pass transistor and a second terminal connected to one selected from the group consisting of a gate and a source of the pass transistor.

14. The adaptive negative impedance system of claim 12, wherein the control input of the variable negative resistance circuit and/or the control input of the variable negative capacitance circuit are connected to an output of the SAB, and an input of the SAB is connected to the gate of the pass transistor.

15. A C-NegC system for adding a negative capacitance across a capacitor of interest without changing an overall capacitance at a signal node, comprising:
a negative capacitance circuit; and
a positive capacitance element,
wherein the negative capacitance circuit is connected between the signal node and a first supply rail, and
wherein the positive capacitance element is connected between the signal node and a second supply rail.

16. The C-NegC system of claim 15, wherein the negative capacitance circuit has an equivalent negative capacitance equals in magnitude to a capacitance of the positive capacitance element.

17. An R-NegR system for adding a negative resistance across a resistor of interest without changing an overall resistance at a signal node, comprising:
a negative resistance circuit; and
a positive resistance element,
wherein the negative resistance circuit connected between the signal node and a first supply rail, and
wherein the positive resistance element connected between the signal node and a second supply rail.

18. The R-NegR system of claim 17, wherein the negative resistance circuit has an equivalent negative resistance equals in magnitude to a resistance of the positive resistance element.
